(19) United States
(12) Patent Application Publication
(10) Pub. No.: US 2015/0187228 A1
(43) Pub. Date: Jul. 2, 2015

(54) INTERACTIVE MEDICAL EDUCATION METHOD AND SYSTEM

(71) Applicant: Precision Medicine Network, Inc., Town and Country, MO (US)

(72) Inventors: Mark S. Boguski, Chestnut Hill, MA (US); Richard Kellner, Town and Country, MO (US)

(21) Appl. No.: 14/582,283

(22) Filed: Dec. 24, 2014

Related U.S. Application Data
(60) Provisional application No. 62/039,466, filed on Aug. 20, 2014.
(60) Provisional application No. 62/025,071, filed on Jul. 16, 2014.
(60) Provisional application No. 61/920,516, filed on Dec. 24, 2013.

(51) Int. Cl. G09B 23/28; G09B 5/06; G06F 17/30; G06F 19/00

(52) U.S. Cl. CPC G09B 23/28; G06F 19/324; G06F 19/345; G09B 5/06; G06F 17/30477; G06F 17/30554

(57) ABSTRACT

An interactive educational and decision making method and system predominantly pertains to information associated with the diagnosis, treatment, and continued learning that is associated with the innumerable forms of cancer and other diseases. Preferably, a web or mobile application is employed that allows users to quickly and simply understand a variety of highly technical molecular and genetic information pertaining to these cancers, and make calculated medical decisions. Physicians can upload patient specific data to a separate HIPAA compliant database. Specific patient data can then be used in conjunction with the application to arrive at an effective genomic or biomarker-based treatment. The decision making process may involve at least tumor types, pertinent genes, signaling pathways, targeted drugs, and genetic and other molecular tests. These tools provide information to administer targeted methodologies to treat and diagnose cancer based on genomic data by combining elements of pharmacology, biology, and pathology and laboratory medicine.

### CLAIM OF PRIORITY

This application claims the priority of U.S. Ser. No. 62/039,466 filed on Aug. 20, 2014; U.S. Ser. No. 62/025,071 filed on Jul. 16, 2014 and U.S. Ser. No. 61/920,516 filed on Dec. 24, 2013, the contents of which are fully incorporated herein by reference.

### FIELD OF THE INVENTION

The field of the invention relates to methods of presenting and using medical information via a mobile or web based platform namely, presenting information applicable to the treatment and decision making involved in treating various disease states. In particular, to providing a fully integrated oncological platform that harmonizes traditional pathology and laboratory medicine with molecular systems biology and clinical pharmacology.

### BACKGROUND OF THE INVENTION

The invention relates to providing healthcare providers (HCP) and patients with integrated, visual/pictorial, and streamlined information about molecular subtypes of cancer and matched targeted pharmacotherapies for both education and clinical decision support on a mobile computing device such as a “smartphone” or tablet or the like. Currently, this information is available in isolated information silos in dense, textual form (e.g. articles in medical journals, specialized textbooks, FDA product labels, etc.) through a variety of physical library resources and/or different desktop computer interfaces. The currently prevalent art is unsatisfactory because information retrieval is non-standardized, tedious and time-consuming. Additionally, it also forces HCPs to communicate with each other and with patients in ad hoc, inefficient and inconsistent ways.

Furthermore, the diagnosis and management of cancer and other diseases and medical conditions is increasing in complexity and sophistication due to rapidly-advancing knowledge and understanding of the molecular mechanisms underlying disease, and a corresponding shift from single analyte to multi-analyte diagnostics requiring new methods of data integration, visualization and understanding for precision diagnosis and personalized medicine. The currently prevalent art is unsatisfactory because it requires HCPs, such as pathologists and oncologists, to devise ad hoc solutions on demand to process, interpret, and explain this information to each other and patients. For example, pathologists have resorted to creating “cheat sheets” consisting of lists of single analyte diagnostics that are critical information resources used to communicate precision diagnoses to oncologists. The oncologists must then use this information to create and deliver a personalized care plan using targeted pharmacotherapies. In explaining the rationale for the use of a particular targeted drug in a specific case, oncologists typically resort to creating hand-drawn diagrams on paper or using presentation software to communicate with patients or other HCPs. For example, those professionals that comprise multidisciplinary tumor boards that oversee and advise on patient management. The invention will enable practitioners to accurately, efficiently and economically educate and communicate complex, multidimensional information to doctors, patients and other members of health care delivery systems.

The invention will also enable healthcare policy and reimbursement specialists, pharmacy benefits managers, insurers, healthcare executives, pharmaceutical and diagnostic marketing and sales representatives, etc. to understand the use of precision diagnostics and personalized medicine as they relate to all aspects of healthcare delivery and value.

### Review of Related Technology:

U.S. Pat. No. 8,562,357 discloses a computerized educational method and system that provides educational content using a simulation situation. In one embodiment, one or more medical conditions and a question may be presented about a hypothetical patient using a video display system. The learner may select from a plurality of potential responses to the question. Typically, the plurality of potential responses is categorized into a correct category, a reasonable category, and a wrong category. Upon receiving a selection from the plurality of potential responses, the learner is provided with the category to which the selected response corresponds.

U.S. Pat. No. 6,988,088 discloses a system for adaptive medical decision support. The invented system provides a system that allows users to efficiently enter, access, and analyze medical information, without disrupting patient-doctor interactions or medical facility course of business; which assists in all stages of medical assessment and treatment; and which is tailored to the particular medical practice or specialty and taking into account the developing habits, preferences, performance, and individual patient histories, of an individual user. The invention provides a learning capacity configured to learn previously presented data and decisions and predict data or decisions based on data that it receives from the user, thereby adapting its operations to the developing habits, preferences, performance, and individual patient histories of an individual user. The system may also provide a “virtual specialist” feature, whereby the system can be instructed to produce the probable actions or recommendations of particular medical specialists.

U.S. Patent Application 2012/0323600 discloses a drug management system based upon membership genomic data that is coupled to cooperating external computing systems via an object server which prepares drug use reports for automated delivery in response to results that data output from the member database. Based on rules stored in a rules library a query engine runs tests on the stored member genetic information to identify and meet specified criteria.

WO2012/094718 discloses methods, systems, and articles, such as computer program products, including a method for managing presentation of information, performed by execution of computer readable program code by a processor of a computer system, is disclosed. The method includes retrieving information relating to one or more subject matters from one or more data repositories, the one or more subject matters including general non-personal information on medical conditions and treatments therefore, presenting one or more sets of data from the retrieved information specific to a practitioner type selectable by a user from a plurality of practitioner types, presenting another one or more sets of data from the retrieved information common to two or more practitioner types selectable from the plurality of practitioner types, and presenting a further one or more sets of data from the retrieved information specific to at least one non-practitioner type.

Various devices and methodologies are known in the art. However, their structure and means of operation are substantially different from the present disclosure. The other inventions also fail to solve all the problems taught by the present disclosure. They do not provide methods or systems that can be used as an interactive learning tool by medical professionals and non-professionals alike.

The current disclosure provides for a novel method of presenting educational materials particularly pertaining to targeted oncological treatments. By using genomic data and interactive educational systems combined with real life decision making, the current invention provides a seamless learning experience and decision making tool across multiple disciplines for a multitude of backgrounds. At least one embodiment of this invention is presented in the drawings below and will be described in more detail herein.

### SUMMARY OF THE INVENTION

A method of presenting and using educational material is described and taught having the steps of providing a computer readable storage medium storing one or more programs for execution by one or more processors, wherein the one or more programs has instructions for providing an interactive medical information application to a wired or wireless device, the interactive medical information application having a database containing non-descriptive patient information; accessing the interactive medical information application, wherein content access is determined by the user credentials at log-in; querying at least one of a plurality of categories of the database of the interactive medical information application, wherein the plurality of categories are based on genetic and molecular cues; and receiving tailored results based on the query.

The educational method and decision making tool may further have the step of providing a separate integrated database for securely uploading, storing, and transmitting diagnostics information, wherein the diagnostics information is reviewed in light of the information contained within the interactive medical information application. In turn, the educational method further is used in making a tailored, genetic, or epigenetic based oncological treatment decision based in part on a review of the interactive medical information application in light of the separate integrated database.

In another aspect of the invention, there is a system of providing educational material having an audiovisual display for displaying and communicating the desired content; a processor based computing device capable of being connected to a network; a computer readable storage medium storing one or more programs for execution by the processor based computing device, wherein the one or more programs has instructions for providing an interactive medical information application to a wired or wireless device, the interactive medical information application having a database containing non-descriptive patient information.

The system may further have a separate, integrated database containing patient information related to diagnostics tests for cancer and various other diseases, wherein the patient information is analyzed using the interactive medical information application aiding medical professionals in decision support, including the recommendation of targeted therapies. Preferably this is done through a multidisciplinary cancer board, or similar types of groups.

The general methodology relates to providing a web or mobile application that provides expansive cross-disciplinary education and information relating to various disease states, namely cancer, which can be used for patient/physician education and decision making. The web or mobile application can generally be accessed from any device having internet capabilities and in some instances offline access may be possible. Such devices may include but are not limited to PDAs, smart phones, laptops, tablets, music players, desktop computers, and gaming systems, and the like or any combination thereof.

A user accesses the application by logging in using credentials provided to them through a subscription based payment plan or through an alternate channel such as occupational access for doctors, nurses, and physicians. In some cases, one can register and receive credentials for free. Some users may need to download the program (application) to the desired internet capable device in order to access the application. This downloading process may require a nominal fee.

Once a user has logged into the system and agreed to the terms and service, privacy statement, and any disclaimer, or the like they are free to explore the information contained therein. The main navigational page has, preferably, at least five searchable categories relating to cancer and its treatment. The searchable categories may include but are not limited to tumor type, biomarker or gene type, signaling pathways, drug type, and genetic and other molecular tests, and radiology/imaging techniques such as CT scans, X-ray, MRI, bone scans, nuclear scans, mammography, ultrasound and the like. Each of the categories has a number of subcategories or explorable sections containing specifically tailored information. For example, a user (physician) may be considering prescribing a patient Erlotinib, a cancer treatment drug. By accessing the application, and searching by a “targeted drug” based on a known affliction or genetic or epigenetic profile, the physician can quickly find all relevant information relating to Erlotinib and the patient at hand. Such information may include names, FDA warnings, approved uses, and common off-label uses. The physician can then view and interact with an interactive schema illustrating the mechanism of the drug pathway. From this interactive schema, the physician can select certain components and receive more information about a certain biomarker or gene, protein, organelle, or the like present in the pathway. This enables the physician to ascertain what alternative options exist and if there are better options for a particular patient based on that patient's data.

This information can then be presented to the patient or even shown in real time to further increase the patient's understanding as well. Additionally, the application is relevant to further the understanding of at least oncologists, radiologists, surgeons, pathologists, radiation oncologists, pharmacists, and primary care physicians. As it pertains to medical professionals, the application may enable more personal information related to the uploading and viewing of patient data in order to fully understand the patient's profile and determine the best way to treat the patient. A patient or general user may find they are able to access more generally known educational data presented in a much more comprehendible format.

In practice, the present invention comprises two parts: Crosswalk ME™ and Crosswalk DS™. The Crosswalk ME™ is the foundational application providing the cross-disciplinary learning experience. Through the aforementioned visual platform, the Crosswalk ME™ creates a seamless learning experience to further the understanding of how diseases, in this case cancer, interact with genetic or epigenetic profiles and, in turn, bases solutions on this genetic or epigenetic data.

The Crosswalk DS™ is a decision support system that is integrated with the Crosswalk ME™ and is HIPAA compliant. The Crosswalk DS™ enables the secure loading, storing, and transmitting of the results of diagnostics testing for cancer and other diseases. The integration of the Crosswalk DS™ and Crosswalk ME™ provides a tool that can be used for educational purposes and decision making between physicians alike. Further, using the pathways and information established by Crosswalk ME™ medical professionals and patients alike can reach a clear understanding of complex information and make connections between genetics or epigenetic and the effective, genetic or epigenetic based tailored treatments for individual patients stemming therefrom.

In general, the present invention succeeds in conferring the following, and others not mentioned, benefits and objectives.

It is an object of the present invention to provide a mobile or web application that seamlessly combines pathology and laboratory medicine with molecular biology and pharmacology.

It is an object of the present invention to provide an educational method of accessing targeted medical information for the targeted treatment of various diseases.

It is an object of the present invention to provide an educational method pertaining to specific cancer tumor types.

It is an object of the present invention to provide an educational method pertaining to specific cancer causing or modifying genes.

It is an object of the present invention to provide an educational method pertaining to cancer signaling pathway(s).

It is an object of the present invention to provide an educational method pertaining to specific, targeted drugs or combinations of drugs to treat cancer.

It is an object of the present invention to provide an educational method pertaining to specific genetic and other molecular tests for cancer diagnoses.

It is an object of the present invention to provide a system for securely loading, storing, and transmitting the results of diagnostic testing for cancer and other diseases.

It is an object of the present invention to provide an educational method relating to various diseases that is understandable by doctors, physicians, nurses, patients, and patient's families alike.

### BRIEF DESCRIPTION OF THE DRAWINGS

FIG. 1 is a flow chart illustrating an overview of the present invention.

FIG. 2 is an example of a screen shot of a main page of the present invention.

FIG. 3 is an example of a screen shot of the tumor main page.

FIG. 4 is an example of a screen shot of a tumor information page.

FIG. 5 is a representation of a tumor pathway schema in accordance with the present invention.

FIG. 6 is an example of a screen shot of the biomarker or gene main page.

FIG. 7 is a representation of a biomarker or gene information page in accordance with the present invention.

FIG. 8 is a representation of a signaling pathway main page in accordance with the present invention.

FIG. 9 is a representation of a signaling pathway information page in accordance with the present invention.

FIG. 10 is a representation of a signaling pathway schema in accordance with the present invention.

FIG. 11 is an example of a screen shot of the targeted drug main page.

FIG. 12 is an example of a screen shot of a targeted drug information page.

FIG. 13 is an example of a screen shot of a targeted drug pathway schema.

FIG. 14 is a representation of a genetic and molecular tests main page in accordance with the present invention.

FIG. 15 is a representation of a genetic and molecular tests information page in accordance with the present invention.

FIG. 16 is a flowchart illustrating a general method of use of the present invention.

### DETAILED DESCRIPTION OF THE DRAWINGS

A portion of the material in this patent document is subject to copyright protection under the copyright laws of the United States and/or other countries. The owner of such material has no objection to the facsimile reproduction by anyone of the patent document or the patent disclosure, as it appears in the United States Patent and Trademark Office publicly available file or records, but otherwise reserves all copyright rights whatsoever.

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

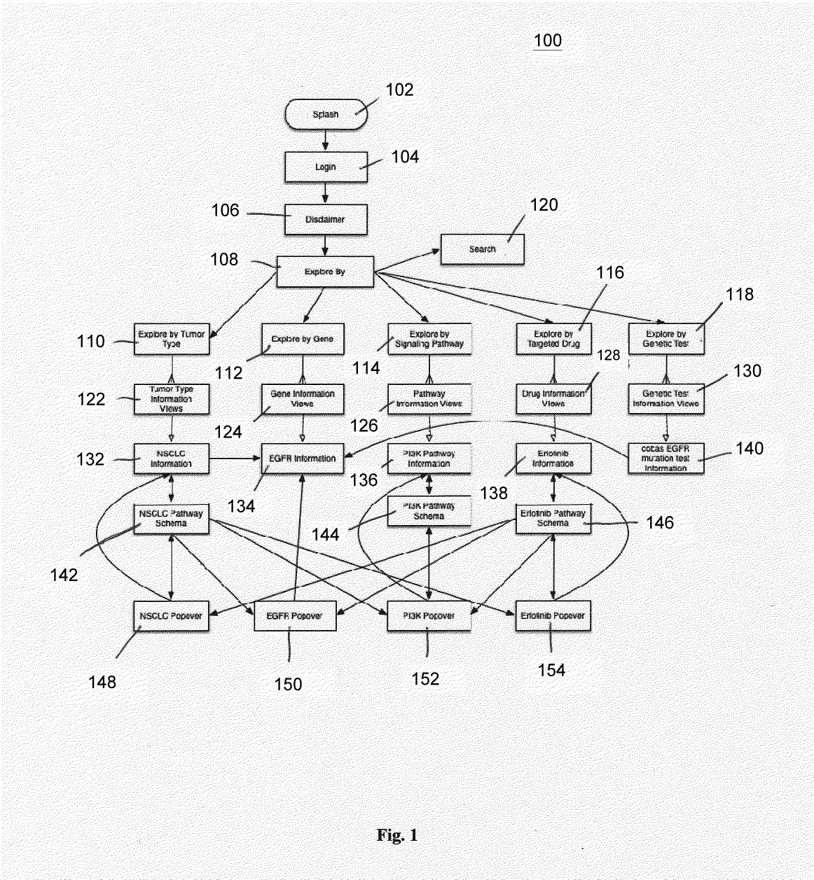

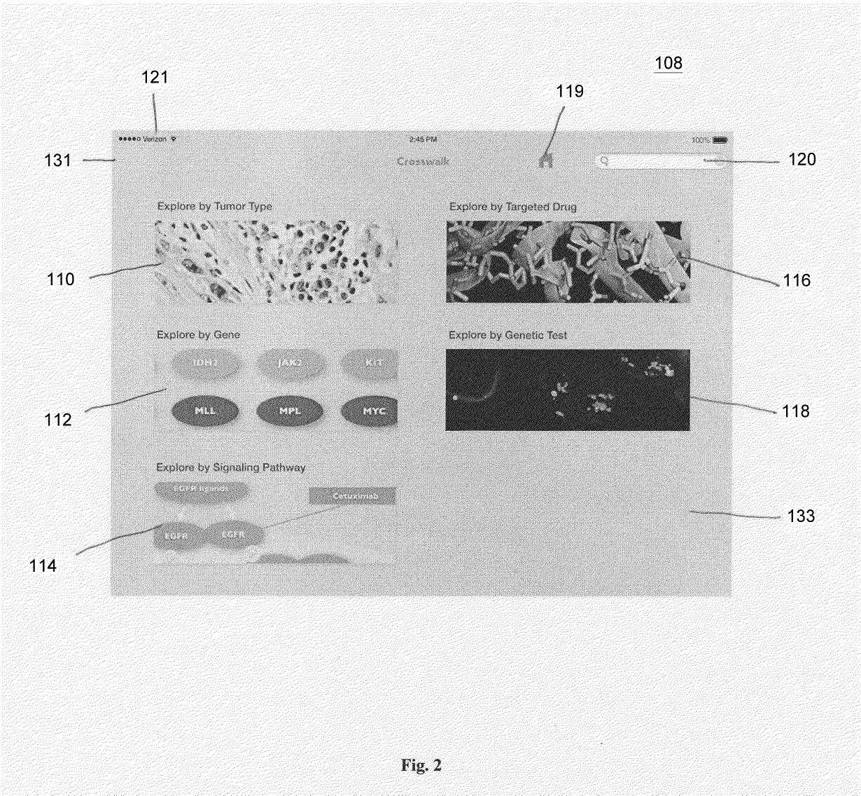

Referring now to FIG. 1, there is a flowchart illustrating an overview of the application 100 of the present invention. Upon opening the application 100, the user is greeted with a splash screen 102. The splash screen 102 may contain such information as the name or trademark of the application 100, various newsfeeds/updates, images, and a log-in feature 104. Through the log-in feature 104, the user can input their credentials to access the system (typically a username and password, but may comprise biometrics and the like). The user is then optionally met with a disclaimer and/or terms of use 106. The disclaimer 106 may further be present on the splash screen 102 or interspersed on individual “pages” of the application. The user is then greeted with a main page or “explore by” page 108 (see FIG. 2). There are a number of options present on this screen and preferably six different methodologies by which to search. A user can choose to search or explore by tumor type 110, explore by biomarker or gene 112, explore a signaling pathway 114, explore by a targeted drug 116, or explore by genetic and other molecular tests 118.

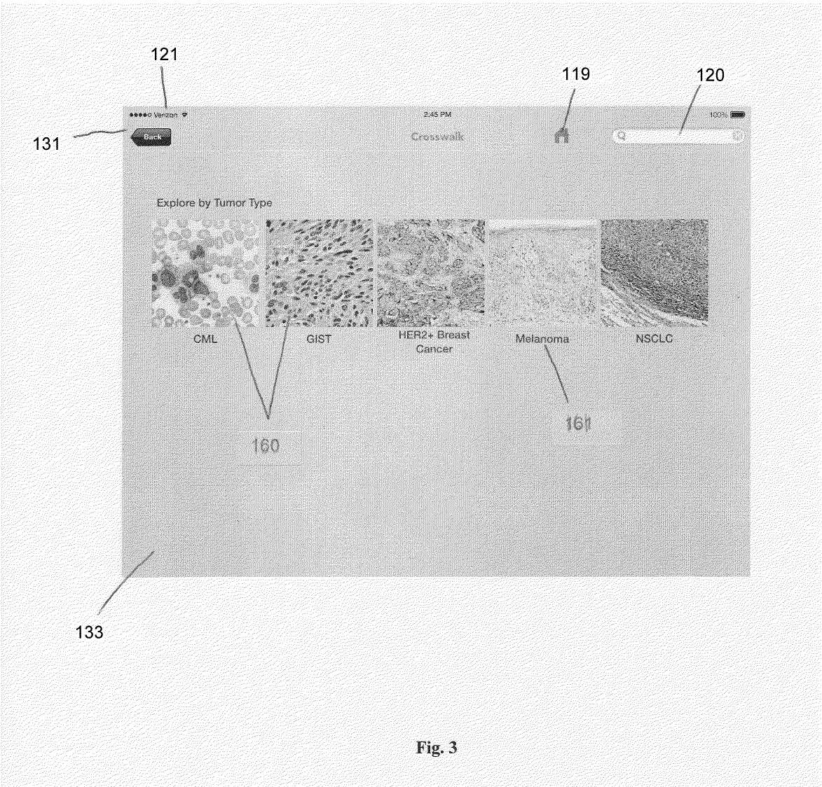

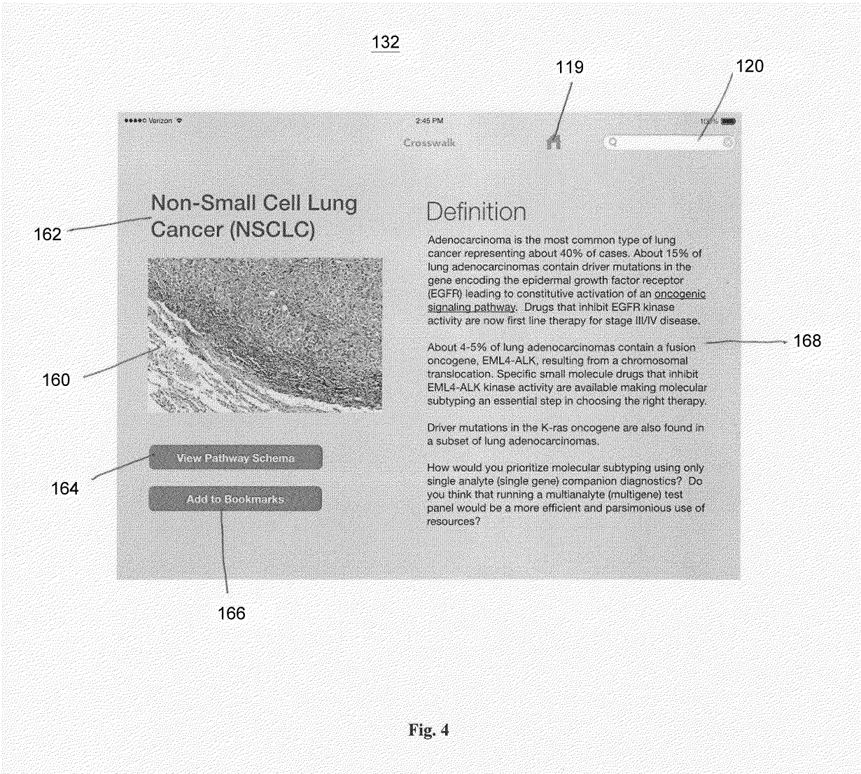

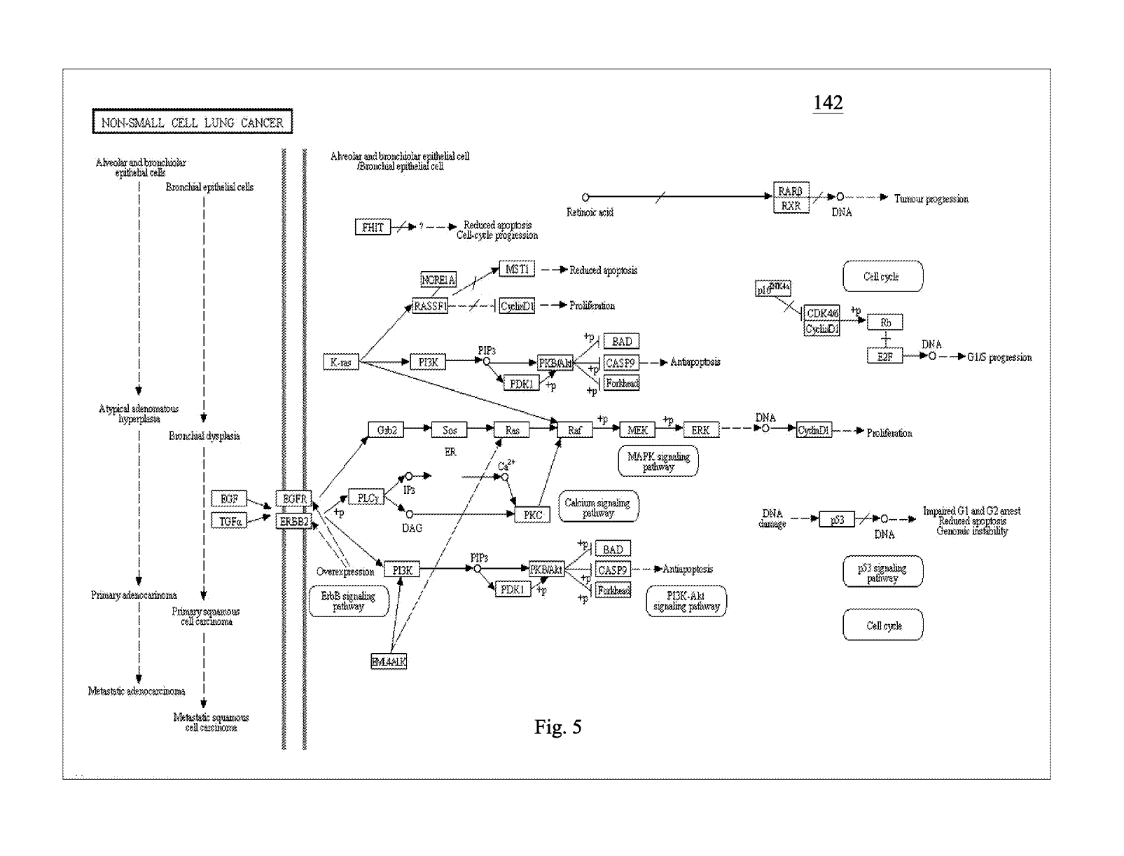

A user may pick to explore by the tumor type 110 by selecting the corresponding area of the visual display. The user is then prompted with audio, visual, or some combination thereof of various tumor types associated with the various forms of cancer 122 (see FIG. 3). The application could contain the option to select from at least 50 different tumor types. By selecting the area of the visual display associated with one of the tumor types, the user is then taken to a tumor information page 132 (see FIG. 4). The page lists various information associated with the selected tumor presented in an audio, visual, or a combination thereof format. Further, a user can receive information specific to the functional pathway of that tumor through a tumor pathway schema 142 (see FIG. 5). The tumor pathway schema 142 clearly and graphically demonstrates the cellular pathway that led to the cancerous cells.

Alternatively, the user may choose to explore by a specific gene 112. Choosing this area of the visual display brings the user to a page with a number of biomarkers or genes. There could be at least 45 of the major oncogenes/tumor suppressor biomarkers or genes to select from and as many as at least 150 total oncogenes/tumor suppressor biomarkers or genes. The user selects one of the oncogenes/tumor suppressor biomarkers or genes and is brought to an information page specific to that oncogenes/tumor suppressor biomarker or gene 124.

A user may decide to explore by the signaling pathway associated with a particular form of cancer 114. The user selects the area of the visual display associated with the signaling pathway exploration and is brought to a pathway selection page 126. The pathways contained on this page represent at least the important signaling pathways in cancer biology. A selection of the area of the visual display corresponding to a particular pathway will bring the user to a pathway schema page 144. The pathway schema page 144 contains visual and/or audio information specific to that pathways involvement in the cancer biology.

Even yet, the user may wish to search or explore by a specific targeted drug 116. The area of the visual display that corresponds to the targeted drug can be selected. The various drugs in the database can then be viewed from the drug selection page 128. A user can select a drug of interest by selecting the area of the visual display corresponding to the image of the particular drug. The user is then taken to an information page with information specific to the selected drug 138. The user can further select the targeted drug pathway schema 146 from this information page. From any of the pathway schemas, a user can select an area of the visual display creating a popover which can be used to jump back and forth between the various schemas and supplied information. If none of these options suffice, a search box 120 is provided for the user to conduct a keyword(s) search based on information they would like to learn more about.

FIG. 2 demonstrates a possible layout of the main navigational page or the explore by menu 108 of the present invention. Once a user has successfully logged into the system, they are brought to this explore by menu 108 to determine the area of furthered learning. The explore by menu 108 is broken up into two main components: a header 131 and an information area 133. The header 131 may contain general information and navigational tools. For example, a user can ascertain the wired/wireless signal they are receiving and the signal strength by a network indicator 121. The header also has a home screen button 119. The home screen button 119 is a selectable area of the visual display that can return the user to the explore by menu 108. The header 131 also contains the keyword search box 120, where a user can complete a less restrictive query that may return information contained within any one or all of the information contained within the targeted categories.

The information area 133 of the page contains the targeted information and navigational portion of the present invention. Here, there are a number of selections the user can make including explore by tumor type 110, explore by gene type 112, explore by signaling pathway 114, explore by targeted drug 116, and explore by genetic and other molecular tests 118. Any number of these categories may be available at any given time and the information area 133 may contain more or less than the named categories. Other not previously named categories may be added as is fit and the technology surrounding oncological studies advances. Each of the aforementioned explore by areas is preferably denoted by a selectable or clickable image that corresponds to the descriptor of the explore by menu. Thus, for example, the explore by tumor type 110 option may bear the image of cells of a cancerous tumor. Hovering over or selecting a particular category may prompt the image to play an audio cue such as a tone, song, or sound. Additionally, such an action may give rise to a particular animation of the image or part of the image.

If a user is to select the explore by tumor type 110 option they are brought to the page or screen shown in FIG. 3. Here, the user is presented with a number of images corresponding to various cancer cell types 160. Each image 160 refers to a type of cancerous cells and the user can select from any of the at least 200 cell tumor types recognized by the American Association of Cancer Research (AACR). In order to help a user properly identify the correct tumor type there are descriptors 161 which describe the tumor cells shown in the image. Such descriptors may be CML, GIST, and Melanoma. Once the user has found the particular tumor type they are seeking, the user can select that area of the visual display bringing up information pertinent to that tumor type.

In FIG. 4, there is an example of such an informational screen or a tumor information page 132 showing the user selected a Non-Small Cell Lung Cancer (NSCLC). The information contained on this page is at least as shown in FIG. 4, however, there may be more information shown as becomes available or required. The tumor information page 132 contains multiple type of information pertinent to the selected tumor type. Each page will have an image 160 of the tumor cell(s). The image 160 may be enlargeable or zoomable. The user may be able to pan the image 160. Located near the image 160 and preferably above the image 160 is the tumor descriptor 161. The tumor descriptor 161 comprises the name of the tumor and any associated alternative names or shorthand notation. Most important is the textual description 168. The textual description 168 contains information specific to the selected tumor type. The textual description 168 is a written text describing features, qualities, and aspects associated with the particular tumor type. Some parts of the textual description 168 may comprise hyperlinks which link to other portions of the application containing further information pertinent to the linked word(s). The user may be able to learn about the background of the tumor type or genetic mutations or epigenetic changes that cause the particular type of tumor. Additionally, the tumor information page 132 may contain a link to the pathway schema 164 involved with the tumor. Selecting this button will bring the user to a full page window with a graphical display demonstrating the corresponding tumor pathway schema (see FIG. 5). The user may also choose to bookmark the page 166 by selecting the corresponding area of the visual display. By bookmarking the page, the page will be stored under the user's credentials for ease of access on future visits.

In FIG. 5, there is a graphical image 142 showing the interrelationships of the genetic mutations that can cause or dictate the biological behavior of a particular tumor, in this example, non-small cell lung cancer (NSCLC), as shown by Kanehisa Laboratories of Kyoto University in Japan. Genetic mutations can cause a plethora of issues including tumor growth, metastatic properties, and dependencies on various biological hormones.

Further, the schema can show the downstream effects of the various mutations and how certain drugs target these mutations in order to effectively “treat” the cancer. The graphic is interactive allowing the user to select certain portions of the schema to learn more information about certain portions of the graphic including organelles, biomarkers or genes, ligands, drugs, and the like. By understanding the underlying genetic mutation, behaviors promoted by such mutations may be targeted with drugs such as angiogenesis inhibitors or hormone antagonists. Such drugs may be highlighted by certain pathways. By selecting these portions, a popover may appear allowing the user to explore another portion of the application related to the area the user just selected.

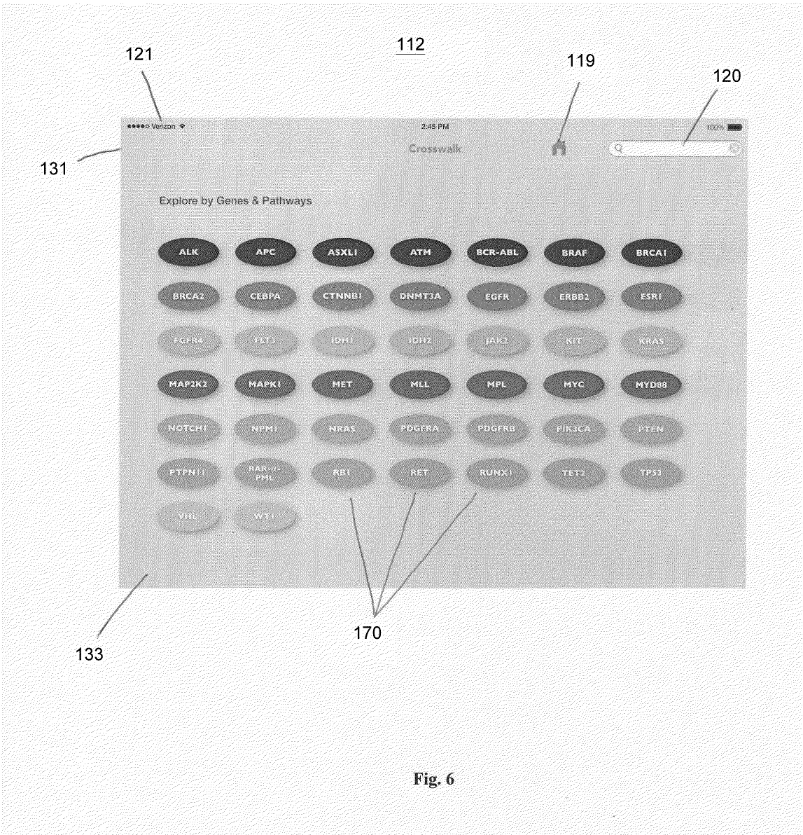

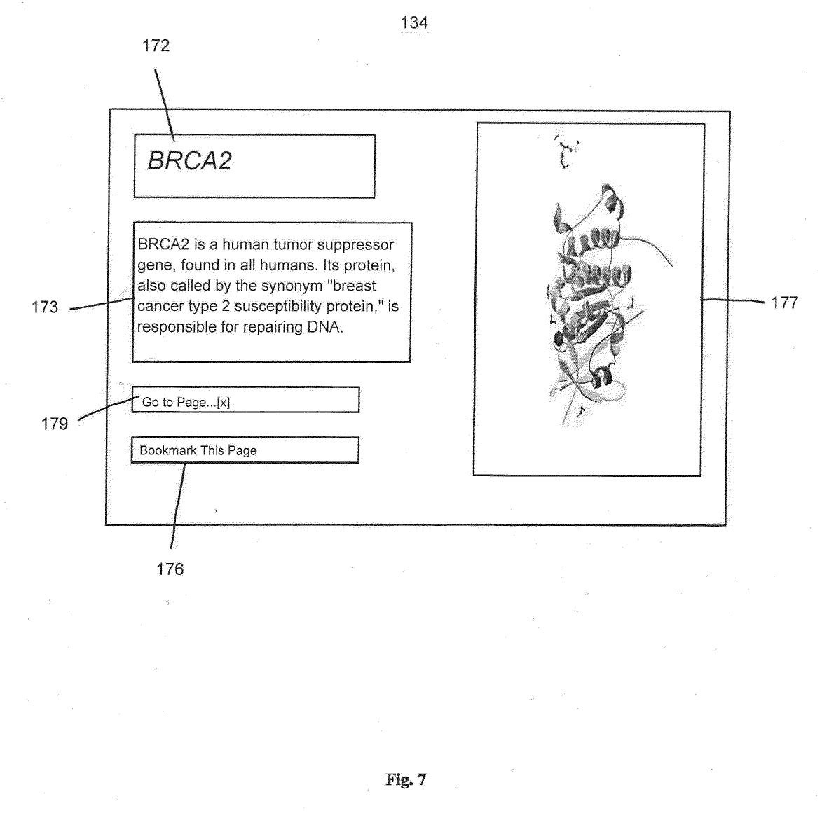

FIG. 6 shows an example of an explore by biomarkers or gene page 112. Here, there is a listing of at least 150 different tumor suppressor genes/oncogenes. Each of the oncogenes/tumor suppressor biomarkers or genes are denoted by a selectable portion of the visual display bearing the name of the biomarker or gene 170. The biomarkers or genes may be grouped according a variety of mechanisms. For example, the biomarkers or genes may be grouped into biomarkers or genes where a hereditary germline mutation causes a predisposition to cancer, grouped where a somatic cell mutation causes a sporadic cancer, or genes in which both commonly occur. The biomarkers or genes may further be divided into oncogenes and tumor suppressor biomarkers or genes. There may also be a selectable filtering mechanism where the user can select certain constraints, whereby biomarkers or genes not meeting the selected criterion are removed from potential selection by the user. Selection by the user of a particular takes the user to a biomarker or gene information page 134 containing information of the selected biomarker or gene as shown in FIG. 7. The biomarker or gene information page 134 contains a textual description 177 of the biomarker or gene and the name 172 of the biomarker or gene. The textual description 177 may contain background information about the biomarker or gene, as well as discussion of proteins or RNA molecules encoded by the biomarker or gene. In addition to a textual description 177 there is also an image of the protein 173 that codes for the protein. The image 173 may be zoomable, enlargeable, or otherwise manipulated by the user. Further information may include, but is not limited to, biomarker or gene symbol, common aliases, and common protein name. The user also has the option to bookmark 176 the page by selecting the corresponding portion of the visual display or jump to another page using button 179.

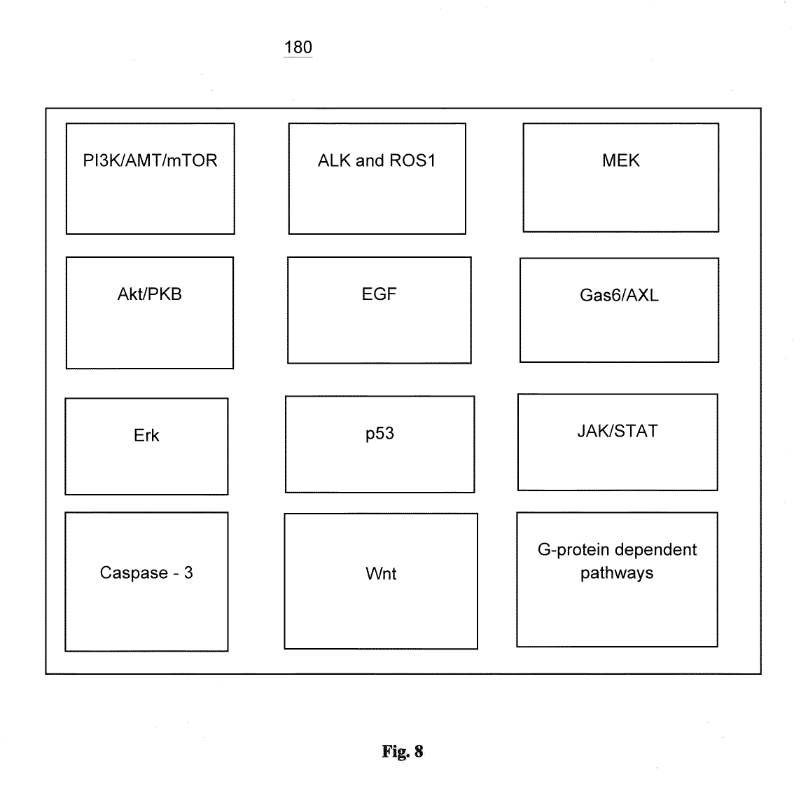

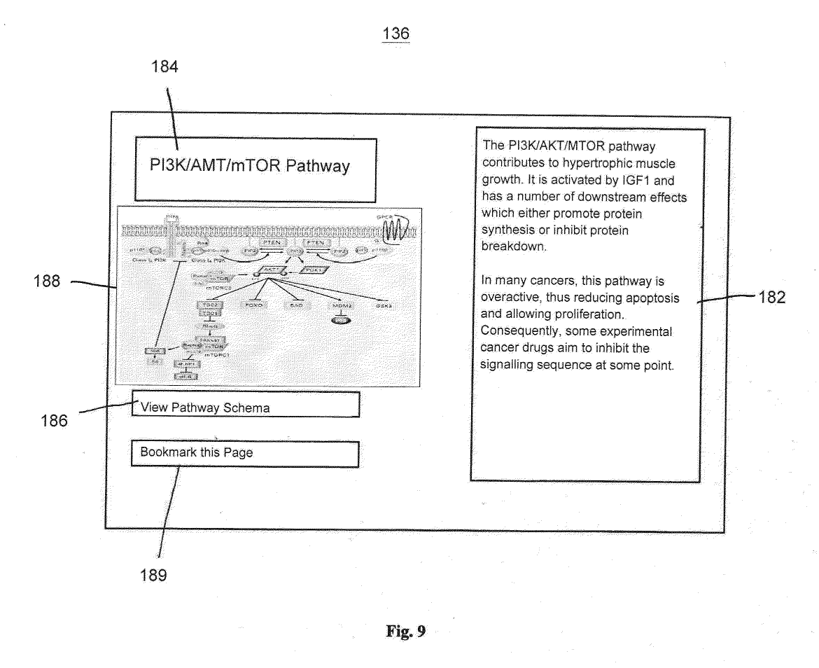

A user may decide to explore by the signaling pathway 114 by selecting the corresponding area of the visual display. Here, the user can select from any one of the number of different signaling pathways 180 as shown in FIG. 8. The signaling pathways are cellular pathways demonstrating the cellular function associated with certain cancer proliferation. A selection of one of the pathways brings the user to a pathway information page 136 shown in FIG. 9.

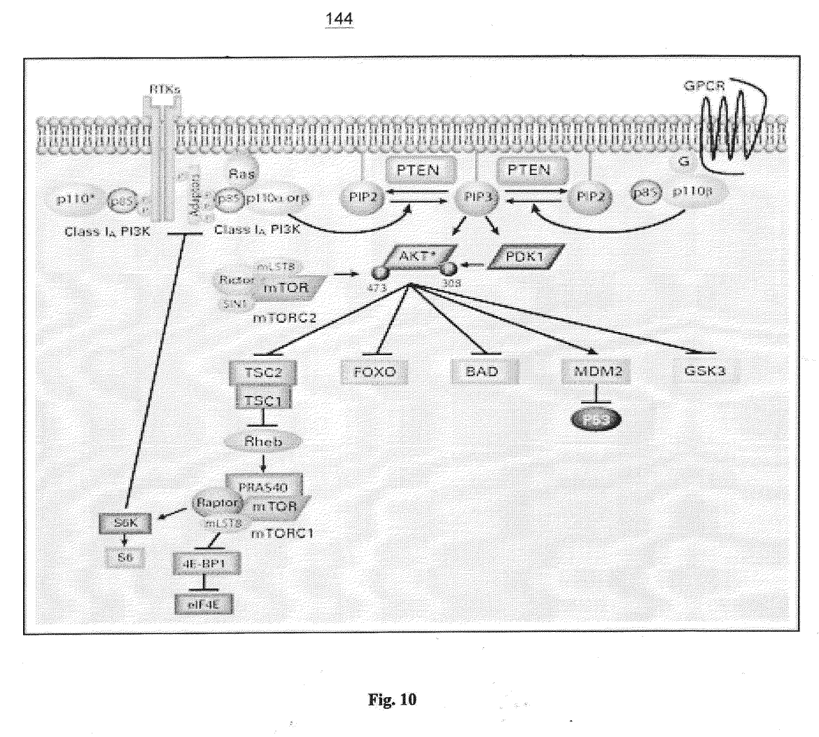

Here, in FIG. 9, there is a textual description 182 of the selected signaling pathway. Such a description may include the major biomarker or gene/protein components and the typical biological results that occur when this pathway is over active. Further, the pathway information page 136 has a denotation for the name 184 of the pathway situated above a condensed image 188 of the pathway. Here, the PI3K/AKT/mTOR pathway has been selected by the user and a representative page is shown. A user may select to view the pathway schema 186 which takes the user to a full screen view of the relevant pathway and associated mechanisms (see FIG. 10) in a similar fashion to those pathways previously described. The user may also bookmark 189 the page for further ease of access in the future.

In FIG. 10, there is a graphical representation of the PI3K/AKT/mTOR pathway 144. The pathway is instrumental in apoptosis, or programmed cell death, and therefore cancer. It is activated by insulin-like growth factor-1 and in many cancers the pathway is overactive. Thus, an understanding of this pathway can be critical in targeting certain cancers. Each part of the pathway may be clickable and take the user to the same or another screen with information related to each component of the pathway.

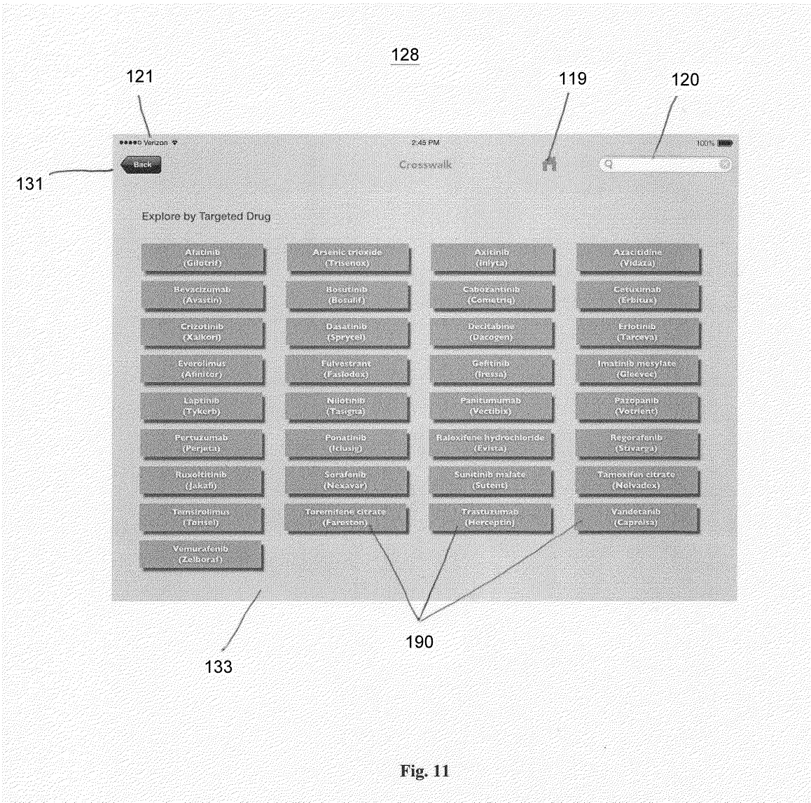

Alternatively, a user may choose to explore by a targeted drug 116 by selecting the relevant portion of the visual display on the navigational page 108. The targeted drug selection screen 128 shows a complete listing of the drugs in the database as shown in FIG. 11. Due to the volume of relevant drugs, a search or filtering feature may be used to narrow the drugs by class, method of use, purpose, etc.

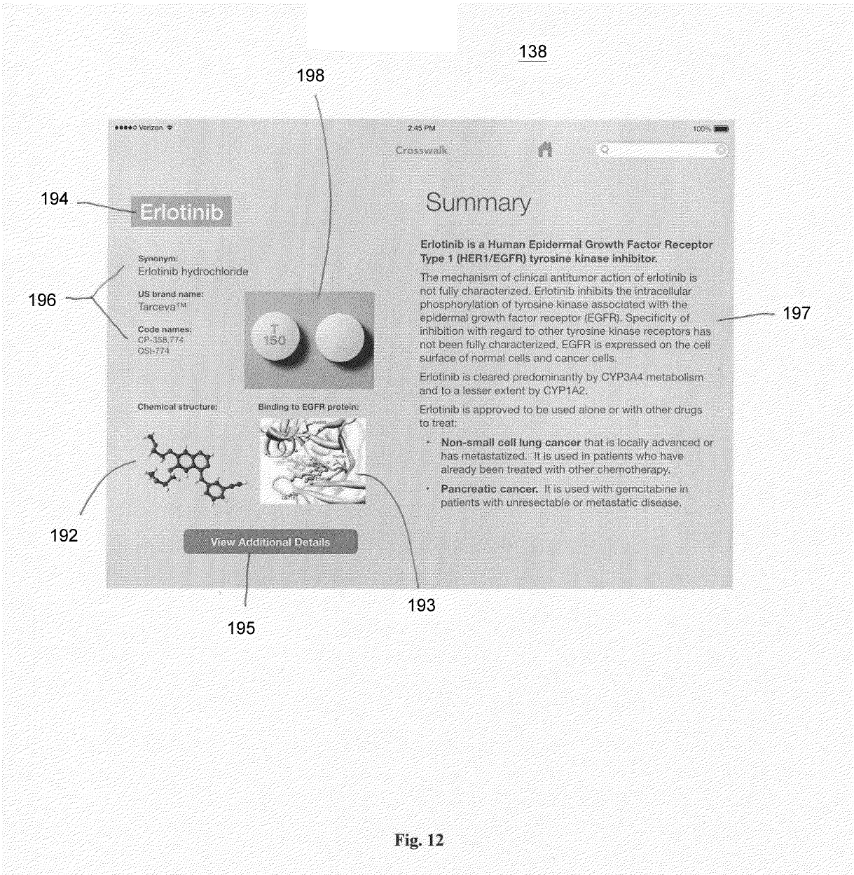

Each of the drug options are represented as selectable or clickable images 190. Each of the images 190 represents an image of the physical drug. By selecting one of the images 190 corresponding to a particular drug, the user is taken to the drug information screen 138 as shown in FIG. 12. The targeted drug information page 138 contains important information concerning the usage and mechanism of the specific drug. The summary 197 is a textual based description of the selected drug. The summary 197 includes any FDA warnings or label warnings at the beginning of the summary 197. Further information in the summary 197 may include, but is not limited to, the mechanism of action, types of cancer treated with the drug, drug interactions.

The targeted drug information page 138 also contains the drug name 194. Below the name, or located proximally thereto, is the relevant other naming information 196. This includes any synonym for the drug name, the brand name of the drug, and the code name(s). There is also an image of the drug 198 showing the important identifying features of the drug. In some instances, it may be necessary to show multiple views of the drug which may be shown side-by-side or as separate selectable images. The screen also preferably shows the chemical structure 192 of the drug. The chemical structure 192 is additionally shown binding to the relevant protein 193 demonstrating this interaction. There is preferably a clickable or selectable button 195 for viewing additional information on the particular drug. By selecting this area of the visual display, the user can read the full FDA label with any associated warnings along with an indicator showing when the label was last updated, thereby providing the user with the most up to date information.

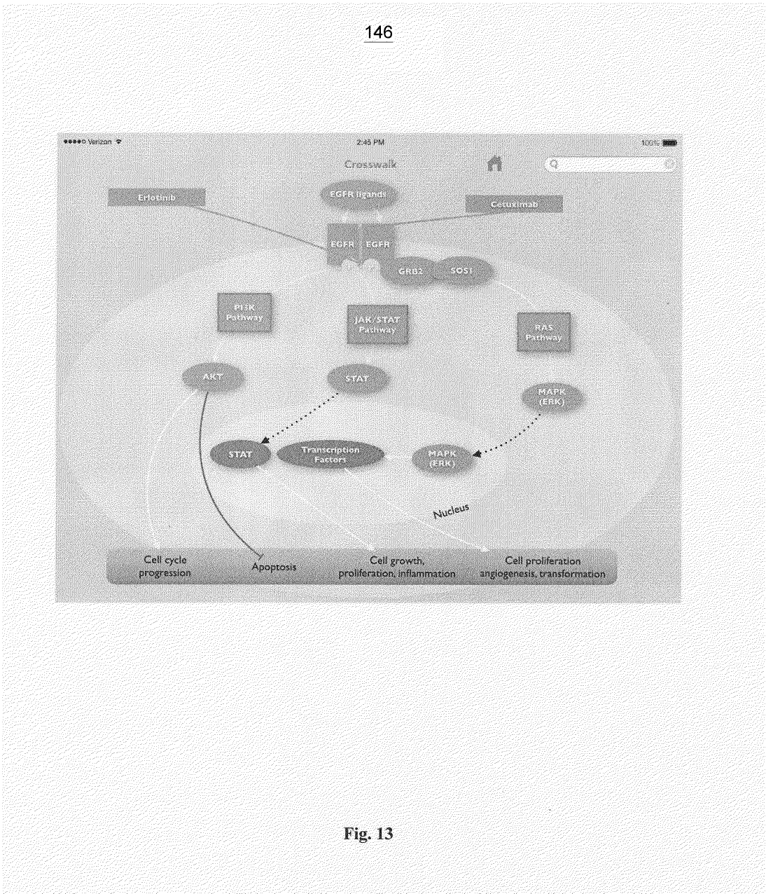

The targeted drug pathway schema 146, as shown in FIG. 13, can give the user a visual representation of the mechanism of action of the drug within the body. The schema includes all the tumor types for which the drug is FDA approved, as well as those for which it is commonly prescribed off label. Further, the schema may include experimental drugs designed to target similar or different biochemical mechanisms. Thus, the schema may provide a visual that could alert a practitioner to eligibility to participate in clinical trials for these experimental drugs.

The goal of the pathway is to clearly and coherently show the protein or RNA targets of the drug and the downstream results of the specific protein targeting. These schemas also provide for interactive pathways allowing the user to select various components including, but not limited to, organelles, ligands, drugs, biomarkers or genes, and the like. By selecting any of these interactive components, a popover is presented, enabling the user to jump to other relevant information and schemas.

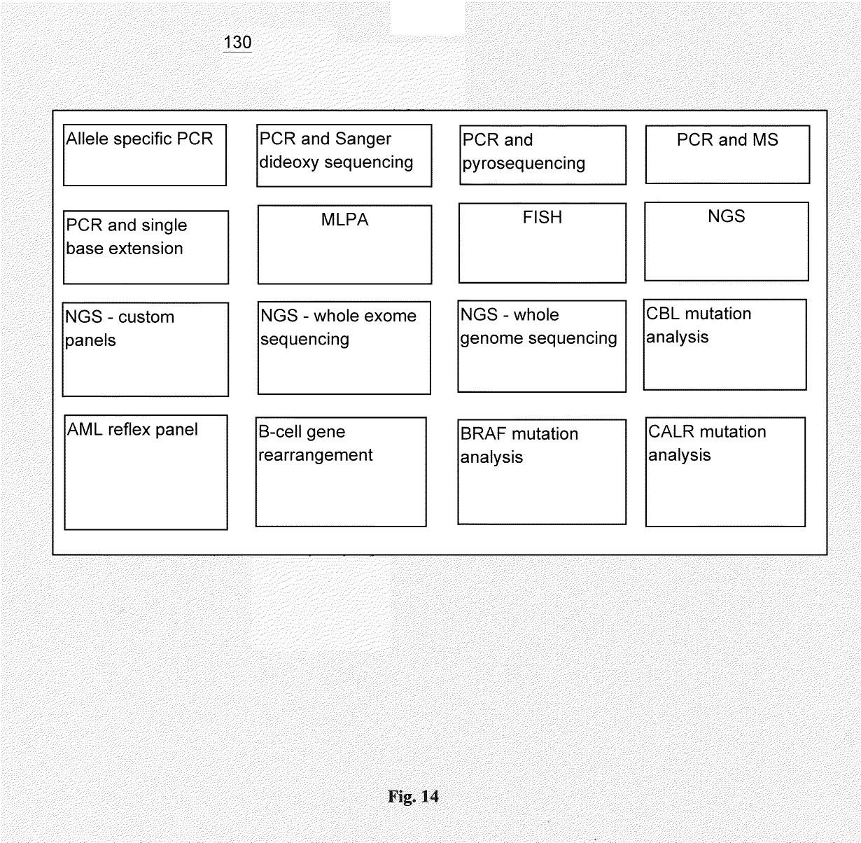

Another option, for the user, is to explore by genetic and other molecular tests 118. A user can then select the appropriate genetic and other molecular test 202 which they desire to learn more about on the genetic and other molecular tests selection page 130 as shown in FIG. 14. These tests may include DNA, RNA, biomarkers or genes, antibodies, proteins, and other chemical analytes or a combination thereof. Each of the genetic and other molecular tests 202 is available as clickable or selectable areas of the visual display.

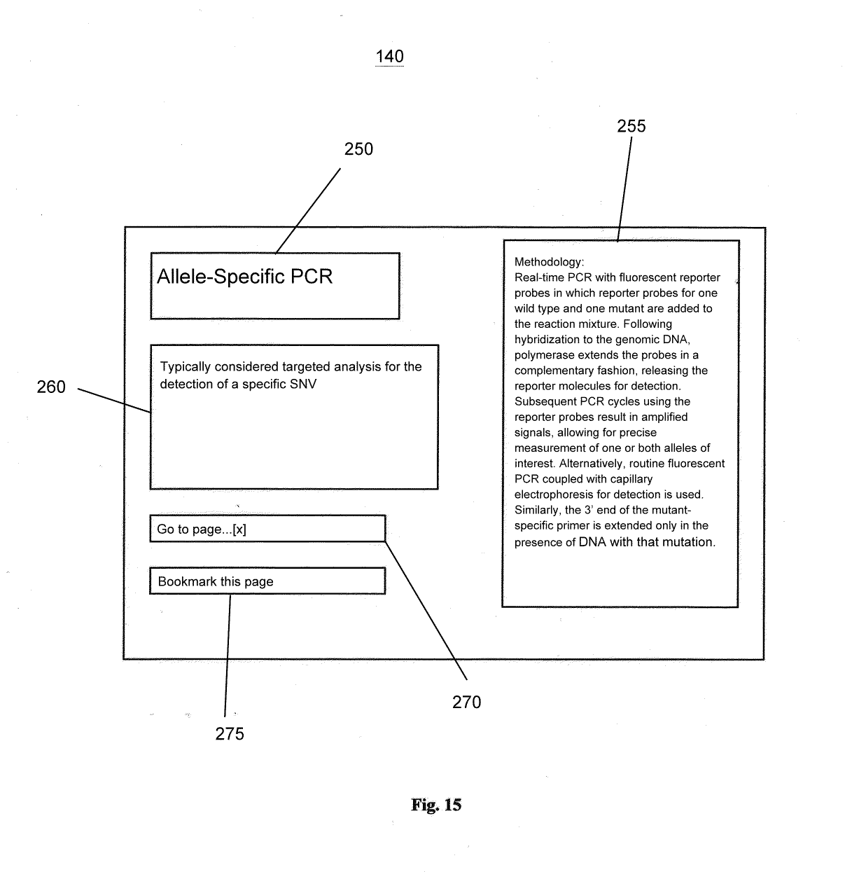

The genetic and other molecular tests may be searchable or be filtered based on a number of criteria, including but not limited to, organ site, biomarker or gene, protein, or cancer type. Once a genetic and other molecular test has been selected, the user is brought to a genetic and other molecular test information page 140 (see FIG. 15).

Here, in FIG. 15, the user can examine such information that may include the test name 250 and test information/methodology 255. The page may, when appropriate, also include a photograph or image of the test. In the test name box 250, this specific test is identified as the “allele-specific PCR” test. The test information/methodology 255 is then described to give one an idea of what/how the test operates. Additionally, in box 260, there is a description of the targeted mutation, marker, cancer, cell, etc. In this example, the test is a targeted analysis for a somatic cell single nucleotide variant (SNV).

As with other similar pages in the system, there is also a clickable button 270 to go to a particular page. The page shown in 270 may be a related page where more information can be obtained, or it may take one back to a page where related tests for a particular marker or similar test types are shown. If a user desires to return to this page at a later date quickly and easily, they can book mark 275 the page. Any further information that may be included on this page can be a description of the type of mutation or molecular marker that is tested, the tumor types that may cause that mutation or marker, and any companion therapies indicated by the results of the test.

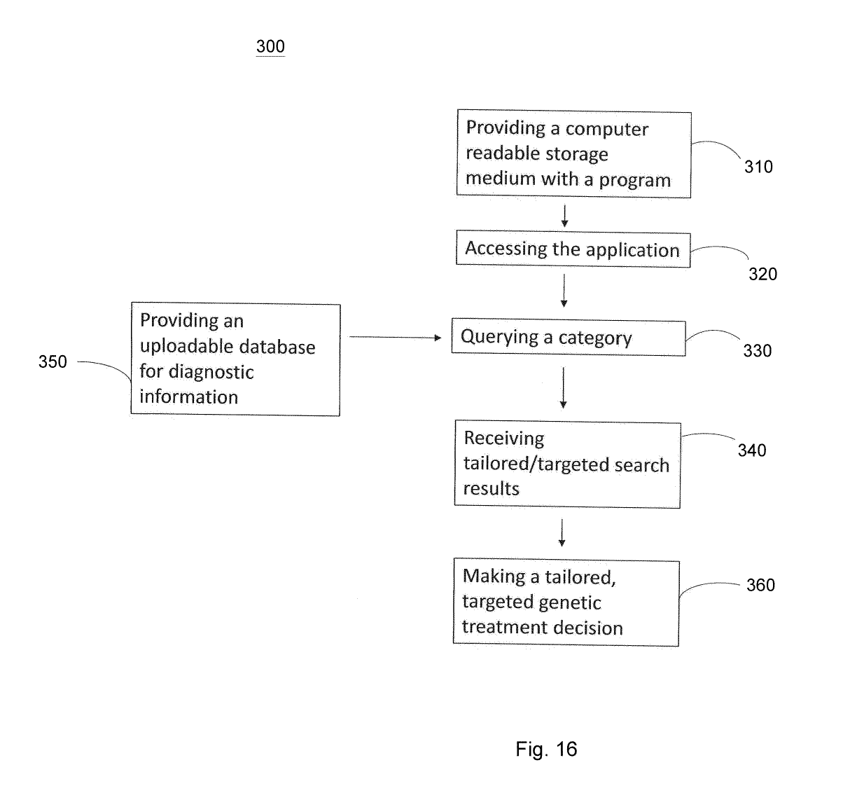

FIG. 16 describes a general method of use of the present invention as intended. The method 300 begins in step 310 by providing a computer readable storage medium containing at least one program, wherein the program is an interactive medical educational program (application).

In step 320, a user can access the application using their user specific credentials. Preferably these will comprise a unique username or password, but could involve a number of items including biometric identifiers, NFC, or the like.

In step 330, the user is able to begin querying the system or a particular category. Alternatively, it may be preferable to revert to step 350 where patient specific diagnostics information is uploaded through a secure, HIPAA compliant connection and database. From there, this information can be used in conjunction the step 330 to create a customized search for information directly related to that which was previously uploaded.

In step 340, the user gets the results of the tailored query. These can be specific to the patient. For example, a physician with a patient having a non-small cell lung cancer (NSCLC) who tested positive for a particular protein could receive information specific to the type of cancer, the specific protein and associated gene, the signaling pathway influenced by the protein, drug recommendations, and genetic and other molecular tests that may be beneficial or excluded.

Using this information, in step 360, the attending physician(s) can make an informed genetic based treatment decision based on specific data for a particular patient. These types of targeted treatments have been shown to greatly increase the effectiveness of such treatments, and the present invention streamlines that process for all those involved.

What is claimed is:

1. A method of presenting and using educational and decision making material comprising the steps of:
providing a computer readable storage medium storing one or more programs for execution by one or more processors,
wherein the one or more programs has instructions for providing an interactive medical information application to a wired or wireless device,
the interactive medical information application having a database containing non-descriptive patient information;
accessing the interactive medical information application,
wherein content access is determined by the user credentials at log-in;
querying at least one of a plurality of categories of the database of the interactive medical information application,
wherein the plurality of categories are based on genetic and molecular cues; and
receiving tailored results based on the query.

2. The educational and decision making method of claim 1 further comprising providing a separate integrated database for securely uploading, storing, and transmitting diagnostics information,
wherein the diagnostics information is reviewed in light of the information contained within the interactive medical information application.

3. The educational and decision making method of claim 1 further comprising making a tailored, genetic based oncological treatment decision based in part on a review of the interactive medical information application in light of the separate integrated database.

4. The educational and decision making method of claim 1 wherein the non-descriptive patient data contains the results of diagnostics tests for various disease types and associated genetic data.

5. The educational and decision making method of claim 4 wherein the non-descriptive patient data comprises data pertaining to cancer.

6. The educational and decision making method of claim 5 wherein the data comprises information including but not limited to the tumor type, gene type, signaling pathway, targeted drug, genetic and other molecular test, and radiology/imaging techniques.

7. The educational and decision making method of claim 2 wherein the database is HIPAA compliant.

8. The educational and decision making method of claim 1 wherein the wireless device is a smart phone, PDA, lap top, tablet, gaming system, or the like or any combination thereof.

9. The educational and decision making method of claim 1 wherein the wired device is a computer or any device capable of internet access.

10. The educational and decision making method of claim 6 wherein the tumor type data comprises audio and visual information for all 200 tumor types as specified by the AACR.

11. The educational and decision making method of claim 6 wherein the gene data comprises audio and visual information for at least 150 oncogenes and tumor suppressor biomarkers or genes.

12. The educational and decision making method of claim 1 wherein the information is presented by a genetic counselor to a medical professional or non-medical professional.

13. A system of providing educational and decision making material comprising:
an audiovisual display for displaying and communicating the desired content;
a processor based computing device capable of being connected to a network;
a computer readable storage medium storing one or more programs for execution by the processor based computing device,
wherein the one or more programs has instructions for providing an interactive medical information application to a wired or wireless device,
the interactive medical information application having a database containing non-descriptive patient information.

14. The system of claim 13 wherein the computer readable storage medium further contains instructions, that when executed on the processor based computing device, further causes the computing device to retrieve specific oncological data based on user queries.

15. The system of claim 13 wherein the interactive medical information includes but is not limited to radiologic imaging, diagnostics, scans, laboratory results or any combination thereof.

16. The system of claim 13 further comprising a separate, integrated database containing patient information related to diagnostics test for cancer and various other diseases,
wherein the patient information is analyzed using the interactive medical information application aiding medical professional in decision support making including the recommendation of targeted therapies.

17. The system of claim 16 wherein the decision support making is done in multidisciplinary cancer boards.

18. The system of claim 16 wherein the database permits the uploading and retrieval of at least information pertaining to specific clinical and histopathologic diagnosis, molecular subtype of tumor, results of radiologic imaging, and targeted drug therapies.
